(19) United States
(12) Patent Application Publication
(10) Pub. No.: US 2008/0163617 A1
(43) Pub. Date: Jul. 10, 2008

(54) POWER IMPLEMENT

(75) Inventors: Jan Rodenbeck, Bornhoved (DE); Christian Kellermann, Stapelfeld (DE); Christoph Blum, Solingen (DE)

Correspondence Address: KELLY LOWRY & KELLEY, LLP, 6320 CANOGA AVENUE, SUITE 1650, WOODLAND HILLS, CA, 91367, US

(73) Assignee: DOLMAR GMBH, Hamburg (DE)

(21) Appl. No.: 11/846,898

(22) Filed: Aug. 29, 2007

(30) Foreign Application Priority Data
Aug. 30, 2006 (DE) DE 202006013279.1

(51) Int. Cl. F01N 7/00; F02F 1/42

(52) U.S. Cl. 60/320; 123/41.56; 30/381

(57) ABSTRACT

An internal combustion engine includes a cylinder wall through which an exhaust port with an exhaust port inner surface is routed from a combustion chamber to an exhaust port opening in the cylinder wall. A pipe section is arranged in a section of the exhaust port following the exhaust port opening in the direction of the combustion chamber with a pipe section outer surface, which reduces the heat transfer from the exhaust gas from the exhaust port into the cylinder wall. The pipe section outer surface is spaced from the exhaust port inner surface through an air gap by sections along an entire outer circumference of the pipe section.

### TECHNICAL AREA

The invention relates to a drive arrangement for an implement, more preferably for a chainsaw, with a combustion engine with a cylinder wall through which an exhaust port with an exhaust port inner surface is routed from a combustion chamber to an exhaust port aperture in the cylinder wall, and with a pipe section with a pipe section outer surface arranged in a section of the exhaust port following the exhaust port aperture.

### PRIOR ART

Portliners are known from the prior art. In JP 2004278499 A a combustion engine with an exhaust port is disclosed. The exhaust port is designed elliptically in each of its cross sections. In an outer section of the exhaust port the portliner is inserted, which on facing regions of its outer surface rests against the exhaust port inner surface and can thus be inserted in the exhaust port in a positionally stable manner. The portliner in cross section is substantially circular in shape so that two facing air ports form in longitudinal direction of the portliner between portliner outer surface and exhaust port inner surface to improve the heat insulation.

The described prior art allows to a considerable degree the transfer of heat from the exhaust from the exhaust port to the cylinder wall and thus undesirably high heating of the cylinder of the combustion engine.

### PRESENTATION OF THE INVENTION

### Object Solution, Advantages

The object of the invention is to make available a drive arrangement which reduces the heat transfer from the exhaust gas from the exhaust port to the cylinder wall.

This object is satisfied through a drive arrangement mentioned at the outset with the characterizing features of the main claim. More preferably hand-held implements such as power chainsaws, hedging shears and disc grinders have the drive arrangement.

The heat transfer from the exhaust gas from the exhaust port to the cylinder wall is reduced through a pipe section inserted in the exhaust port section following the exhaust port opening on the inside. The exhaust gas in the exhaust port section no longer flows along in direct contact with the exhaust port inner surface but exclusively in contact with the pipe section inner surface. Since the pipe section outer surface at least by sections along an entire circumference of the pipe section has a distance from the exhaust port inner surface through an air gap an improved since circumferential heat insulating air gap compared with the prior art is created.

Exhaust port and pipe section here mean components with cross sections of undetermined shape. More preferably cross sections of the exhaust port inner surface and the pipe section outer surface can have different shapes. Conceivable are elliptical, egg-shaped, circular and other cross sections. Preferred are the cross sections of the exhaust port inner surface and the pipe section outer surface at least by sections rectangular with rounded corners preferably along their entire length with a horizontally larger and a vertically smaller diameter.

Preferably the air gap extends along the exhaust port section between a termination and the exhaust port opening and on each point of the section along the entire circumference of the exhaust port. Thus the pipe section along its entire length except for the termination is spaced from the exhaust port inner surface through the air gap. Advantageously the air gap is thus particularly large in area.

In order to counteract the entry of hot exhaust gases in the air gap the pipe section in the region of an edge of the pipe section end protruding into the exhaust port forms a termination completely surrounding the exhaust port with the exhaust port inner surface. The termination prevents the gas exchange between combustion chamber and air gap at least substantially. In the most favourable of cases the termination is gastight.

In a preferred embodiment of the invention the exhaust port along the inside of its section intended to accommodate the pipe section has a first cross section which circumferentially about the air gap width is smaller than an outer cross section along the pipe section. Downstream a second smaller cross section follows the first cross section which corresponds to the outer cross section of the pipe section. The pipe section is inserted in the second cross section where at its end it terminates against the cylinder. Further upstream the exhaust port inside merges into a third even smaller cross section which corresponds to the inner cross section along the pipe section.

The termination can be produced cost effectively through the pipe and exhaust port cross sections being matched to each other.

In a further embodiment the exhaust port in a section between the exhaust port opening and the termination has a circular cross section along the entire section with a widened inner diameter and the pipe section inserted in the exhaust port along the entire section has a circular cross section with an outer diameter which is smaller by an air gap width than the inner diameter of the exhaust port.

The termination can also be created through a short conical widening of the exhaust port in the region of the inserted pipe section end against which the pipe section end rests.

The developments described permit the simple insertion of the pipe section in the outer section of the exhaust port. More preferably through interaction with the conical widening a heat insulation system that is easy to handle and cost effective is created.

Preferentially the exhaust port opening permits an exchange of air between air gap and its surroundings. Thus the heat can be transported away before it enters the cylinder wall. The exhaust port opening to the surroundings should preferentially be combinable with a gastight termination in order to prevent exhaust gas escaping from the cylinder via the exhaust port and the exhaust port opening into the surroundings.

In a particularly preferred embodiment of the invention the drive arrangement according to the invention has a silencer on which the pipe section is arranged standing away to the outside. Preferentially the pipe section is provided positionally stable on the silencer. Through the arrangement of the pipe section according to the invention on the outside of the silencer it is possible to insert the pipe section, except for the gastight termination, into the exhaust port without making contact and form a complete circumferential air gap.

In the most favourable of cases the silencer has a housing into which a pipe continuation protrudes and the pipe section on the outside of the housing follows the pipe continuation. Pipe section and pipe continuation can be formed as one piece. Through the one-piece design a heat transport from the pipe section to the pipe continuation is favoured. By means of the pipe section heat is additionally dissipated from the interior of the cylinder.

The one-piece design of pipe section and pipe continuation additionally makes possible the cost-effective manufacture of the component as deep-drawn part.

In a further favourable embodiment of the invention the pipe continuation in the silencer housing is designed bent. Thus a sound dampening effect is achieved which renders the usual use of a shower head superfluous. The pipe continuation possibly also has a resonator effect since it extends the exhaust port. In the most favourable of cases the bent size remains the same along the pipe continuation.

The pipe continuation ends in an opening in the interior of the silencer housing from which the exhaust gases enter the silencer housing, wherein preferentially an inner diameter of the pipe continuation uniformly increases from the pipe section to the opening. As a result, an additional sound dampening effect is achieved.

Preferentially the opening of the pipe continuation is fixed positionally stable to the inner wall of the silencer housing with a fastening. This, at best, acts together with a reinforcement ring at the inlet of the pipe continuation in the silencer housing to stabilise the construction.

In a further particularly preferred embodiment of the invention a gasket is provided between silencer and cylinder. In a favourable case the gasket seals the air gap towards the surroundings. Thus an air exchange between air gap and surroundings is at least substantially prevented. As a result, minor leakages in a termination which is not completely gastight flowing between pipe section and exhaust port into the air gap still do not enter the surroundings. A termination which is not completely gastight can be produced cost-effectively in combination with the gasket.

Particularly cost-effectively the gasket is designed as flat gasket surrounding the exhaust port opening.

### BRIEF DESCRIPTION OF THE DRAWINGS

The invention is described by means of an exemplary embodiment in two figures. There it shows:

FIG. 1 Lateral view of a drive arrangement according to the invention with a cylinder of a 4-stroke internal combustion engine and a silencer,

FIG. 2 Lateral view along the line 11-11 in FIG. 1.

### BEST WAY TO CARRY OUT THE INVENTION

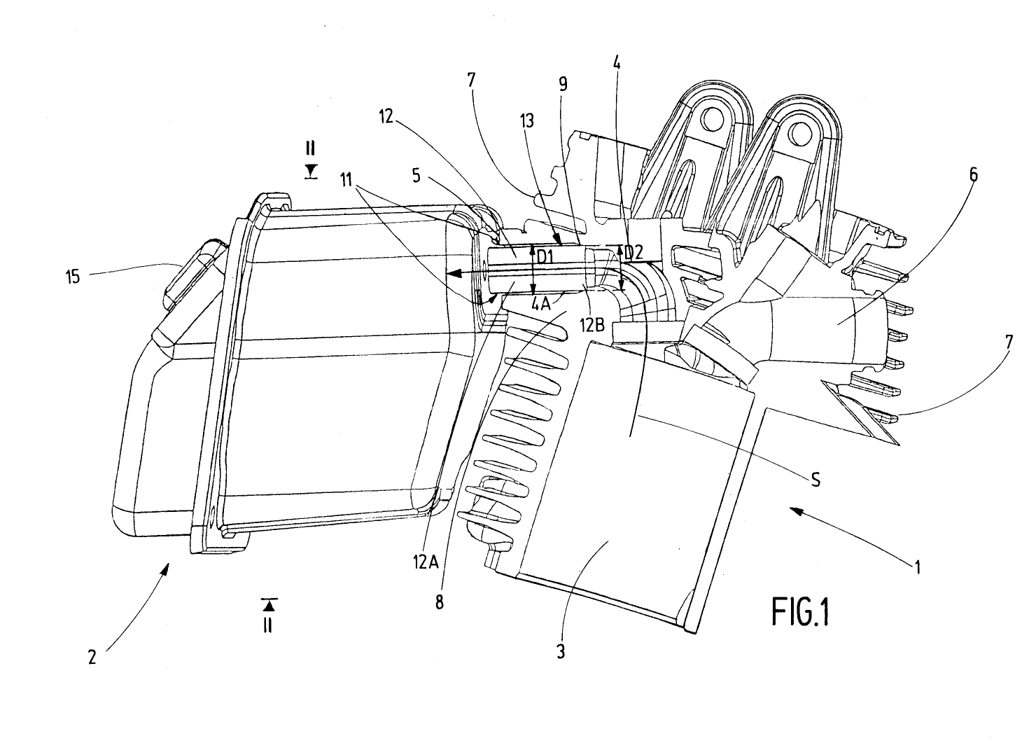

FIG. 1 shows the cylinder 1 of a 4-stroke internal combustion engine and the silencer 2 provided downstream in flow direction S of the exhaust gas. The drive arrangement shown is installed in a power chainsaw and drives its saw chain. The cylinder 1 with its metal cylinder wall 8 encloses a combustion chamber 3 of the 4-stroke internal combustion engine. Via an exhaust port 4 which is almost bent at a right angle and routed along its entire length through the cylinder wall 8 the combustion chamber 3 is connected with the silencer 2. The exhaust port 4 is designed as bore through the cylinder wall 8. Neighbouring an exhaust outlet in the exhaust port 4 the combustion chamber 3 is connected with a fuel-air mixture inlet of a fuel-air mixture port 6.

The cylinder wall 8 has cooling ribs 7 which surround the cylinder vertically to the stroke movement of the (not drawn-in) piston. The cooling ribs 7 dissipate heat generated in the combustion chamber 3 and given off from the combustion chamber 3 and through the exhaust gas from the exhaust port 4 to the cylinder wall 8 to the surroundings.

From a side of the combustion chamber 3 facing away from the floor in operation the exhaust port 4 departs to the silencer 2. The exhaust port 4 is formed in a perpendicular cross sectional surface corresponding to the orientation of the section II-II between cylinder 3 and silencer 2 in a substantially L-shaped manner. At is open end its short L-leg has the exhaust outlet from the combustion chamber 3. It departs at an angle of approximately 20° determined through the installation space available here relative to the stroke movement direction of the side of the combustion chamber 3 which faces away from the floor. Its long L-leg is inclined towards the floor accordingly and routed through the cylinder wall 8 to the outside.

In all cross sections vertically to the exhaust flow direction S in FIG. 1 the exhaust port 4 is substantially rectangular with four equally rounded-off corners but designed with height and greater width. A small inner cross section of the exhaust port 4 in flow direction S immediately after the L-angle on the long L-leg over a first step has a widening 9 towards the widened inner cross section. The widened inner cross section in a second step merges with a large inner cross section of the exhaust port 4 downstream of the widening line as far as the exhaust port opening 11 in the outer surface of the cylinder wall 8. The large inner cross section has a cross sectional height d1 and a larger cross sectional width than cross sectional height. The surface of the widened inner cross section is larger than that of the small and smaller than that of the large inner cross section.

A pipe section 12, departing from the silencer 2, the so-called portliner, is concentrically inserted in the exhaust port 4. In operation, the portliner 12 directs the exhaust gases into the silencer 2. An outer surface 12a and an inner surface of the portliner 12 are formed in every cross section vertically to the exhaust flow direction S in a rectangular manner with identically rounded-off corners. A height d2 of the outer cross section of the portliner 12 is uniformly and slightly smaller along its entire length than the inner cross section of the exhaust port having the height d1. The same applies to the (not drawn-in) widths of the cross sections of the portliner and the exhaust port. The outer surface of the portliner 12 with the inner surface of the exhaust port 4 along the larger inner cross section of the exhaust port 4 forms an air gap 13 of constant width d2-d1 completely surrounding the air gap. The outer cross section of the portliner 12 corresponds to the widened inner cross section of the exhaust port 4 a short distance downstream of the L-angle. By inserting the portliner 12 in the exhaust port 4 the termination 9 is thus formed. The inner diameter of the portliner 12 corresponds to the small inner cross section of the exhaust port 4.

The outer and inner cross sections are substantially identical in shape with different height.

The cross sections of the exhaust port 4 and the portliner 12 described must only be understood exemplarily. Among other things they can also be circular throughout, completely or by sections elliptically, egg-like in shape. At any rate, through interaction they have to form an air gap 13.

Between an outer wall of the silencer 2 and an outer wall of the cylinder 1a flat gasket 5 surrounding the portliner 12 is provided. The flat gasket 5 prevents the escape of exhaust gases which entered the air gap 13 via the termination 9 into the surroundings. Both the termination 9 and the flat gasket 5 are not necessarily gastight.

The air gap 13 still forms a heat insulation layer between portliner 12 and cylinder wall 8. The principle here is comparable with that of a thermos flask.

On the one hand heat created in the combustion chamber 3 through combustion is passed from the combustion chamber directly into the cylinder wall 8. On the other hand, the hot exhaust gases from the combustion chamber 3 during the operation flow in flow direction S along the entire length of the short L-leg of the exhaust port 4 along its inner surface and additionally pass heat on to the cylinder wall 8 in the process. The cylinder 1 is heated up through both effects.

The second effect is reduced through the portliner 12 according to the invention. Because of the air gap 13 created through the portliner 12 inserted in the outer section of the exhaust port 4 the heat transport into the cylinder wall at least along the long L-leg of the exhaust port 4 is reduced and thus additional heating of the cylinder 1 counteracted.

The length of the portliner 12 standing off outside the silencer 2 is greater than the length of the exhaust port section with the large cross section. The outer wall of the portliner 12 touches the inner wall 4a of the exhaust port 4 along the widening 9 and the outer edge of the portliner 12 protruding into the exhaust port 4 seals the first step towards the cylinder 1 through contact with both walls. The shape of the outer circumference of the portliner 12 along the outer edge of the opening protruding into the exhaust port 4 and the shape of the inner circumference of the widening 9 are matched to each other. They form a positive termination.

Having exited the combustion chamber 3 the exhaust gases sweep along the inner wall of the short L-leg and the inner wall of the L-angle and then along the inner wall of the portliner 12 and then flow into the silencer 2.

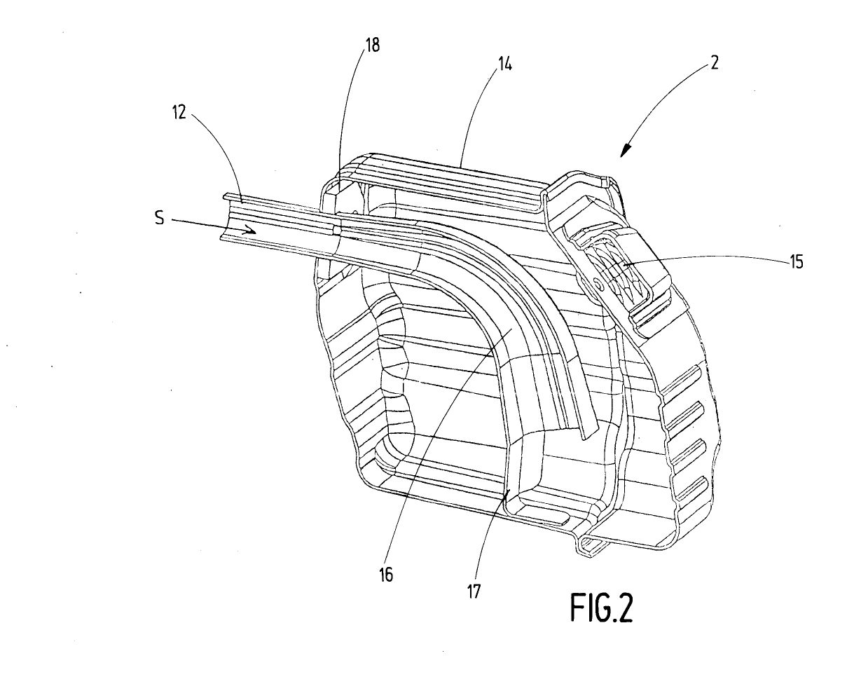

The sectional view of the silencer 2 shown in FIG. 2 is turned approximately 180° about the perpendicular compared with FIG. 1.

The silencer 2 has a sound-insulating silencer housing 14. The exhaust gases enter the silencer 2 in flow direction S via an angled-off pipe which is evenly widening in the silencer 2 and designed as one piece. The angled-off pipe outside the silencer housing 14 forms the portliner 12 and in the interior of the silencer housing 14 a pipe continuation 16. An open end of the pipe continuation 16 is fixed positionally stable relative to the inner wall to the inner wall of the silencer housing 14 by means of a fastening 17. Another version not shown in the drawing consists in that the angled-off pipe is formed by two half-pipes so that the pipe section 12 and the pipe continuation 16 is formed of two parts (half pipes) each forming half a pipe section and half a pipe continuation.

An inlet opening of the silencer housing 14 is reinforced with a reinforcing ring 18. The portliner 12 with its outer surface is routed through the inlet opening gastight relative to the silencer housing 14.

The portliner 12 is connected in a positionally stable manner with the silencer housing. The positionally stable arrangement of the portliner 12 through positionally fixed fixing of the silencer 2 relative to the 4-stroke internal combustion engine 1 allows inserting the portliner 12 concentrically from the outside in the exhaust port 4 and in this way to form an air gap 13 uniformly surrounding said port and to maintain the air gap 13 permanently and during the operation.

The exhaust outlet 15 is provided on the side of the silencer 2 facing away from the internal combustion engine.

### LIST OF REFERENCE NUMBERS

1 Cylinder
2 Silencer
3 Combustion chamber
4 Exhaust port
4a Exhaust port inner surface
5 Gasket
6 Fuel-air mixture port
7 Cooling ribs
8 Cylinder wall
9 Widening, termination
11 Exhaust port opening
12 Portliner/pipe section
12a Pipe section outer surface
12b Pipe section end
13 Air gap
14 Silencer housing
15 Exhaust outlet
16 Pipe continuation
17 Fastening
18 Reinforcing ring
d1 Large inner diameter of the exhaust port
d2 Outer diameter of the portliner/pipe section
S Exhaust flow direction

1. A drive arrangement for an implement including an internal combustion engine, comprises:
a cylinder wall through which an exhaust port with an exhaust port inner surface is routed from a combustion chamber to an exhaust port opening in the cylinder wall, and
a pipe section arranged in a section of the exhaust port following the exhaust port opening in the direction of the combustion chamber with a pipe section outer surface;
wherein the pipe section outer surface, at least by sections, is spaced along an entire outer circumference of the pipe section from the exhaust port inner surface through an air gap.

2. The drive arrangement according to claim 1, characterized in that the air gap extends along a section of the exhaust port between a termination and the exhaust port opening and along the section along the entire inner circumference of the exhaust port.

3. The drive arrangement according to claim 1, characterized in that the pipe section in the region of a pipe section end protruding into the exhaust port forms a termination with the exhaust gas port inner surface which completely surrounds the exhaust port.

4. The drive device according to claim 3, characterized in that a small inner cross section of the exhaust port in flow direction (S) increases in size in a step to the widened inner cross section and in a second step to the large inner cross section and the pipe section on the pipe section end inserted in the exhaust port has an outer cross section which corresponds to the widened inner cross section.

5. The drive device according to claim 4, characterized in that an inner diameter of the pipe section corresponds to the small inner diameter of the exhaust port.

6. The drive arrangement according to claim 4, characterized in that the exhaust port in a section between the exhaust port opening and the termination along the entire section has a circular cross section with a large inner diameter and the pipe section inserted in the exhaust port along the entire section, has a circular cross section with an outer diameter which is smaller than the large inner diameter.

7. The drive arrangement according to claim 3, characterized in that the termination is gastight.

8. The drive arrangement according to claim 1, characterized through a silencer from the outside of which the pipe section stands away.

9. The drive arrangement according to claim 8, characterized that the pipe section is arranged on the silencer in a positionally stable manner.

10. The drive arrangement according to claim 9, characterized in that the silencer has a silencer housing in which a pipe continuation protrudes and the pipe section on the outside follows the pipe continuation.

11. The drive arrangement according to claim 10, characterized in that the pipe section and the pipe continuation are formed in one piece or that the pipe section and the pipe continuation are each formed of two parts (half pipes) forming a half pipe section and a half pipe continuation.

12. The drive arrangement according to claim 11, characterized in that the pipe section and the pipe continuation are formed as a deep-drawn part.

13. The drive arrangement according to claim 10, characterized in that the pipe continuation is bent.

14. The drive arrangement according to claim 13, characterized in that the bend along a pipe longitudinal direction of the pipe continuation substantially has a size that remains the same.

15. The drive arrangement according to claim 10, characterized in that the pipe continuation has an opening in the interior of the silencer housing and an inner diameter of the pipe continuation increases in size from the pipe section in the direction of the opening in the interior of the silencer housing.

16. The drive arrangement according to claim 15, characterized through at least one fastening of the opening of the pipe continuation to an inner wall of the silencer housing.

17. The drive arrangement according to claim 8, characterized through a reinforcement ring at the entry of the pipe continuation in the silencer housing.

18. The drive arrangement according to claim 8, characterized through a gasket between the silencer and a cylinder.

19. The drive arrangement according to claim 18, characterized in that the gasket seals an air gap in the direction of the surroundings.

20. The drive arrangement according to claim 19, characterized in that the gasket is formed as a flat gasket surrounding the exhaust port opening.

21. A power chainsaw with a drive arrangement according to claim 1.
